(19) United States
(12) Patent Application Publication
(10) Pub. No.: US 2004/0073651 A1
(43) Pub. Date: Apr. 15, 2004

(54) Secure system and method for providing a robust radius accounting server

(75) Inventors: Annette Beaulieu, Saint-Jeannet (FR); Fabrice Livigni, Mougins (FR); Gerard Marmigere, Drap (FR)

Correspondence Address: HOFFMAN WARNICK & D'ALESSANDRO, LLC, 3 E-COMM SQUARE, ALBANY, NY, 12207

(73) Assignee: International Business Machines Corporation, Armonk, NY (US)

(21) Appl. No.: 10/680,849

(22) Filed: Oct. 7, 2003

(30) Foreign Application Priority Data
Oct. 10, 2002 (EP) 02368111.7

(51) Int. Cl. G06F 15/173

(52) U.S. Cl. 709/223; 709/225

(57) ABSTRACT

A method for providing robustness to the accounting function of user sessions established by at least one NAS in an IP network, the accounting function being performed on a RADIUS server storing an ID, IP address and secret code for each NAS and information identifying each established session. The method includes identifying for the RADIUS server, the agent as a RADIUS client of the RADIUS server, polling from the agent all the NAS identified in said RADIUS server and, if no answer is received from at least one NAS, sending from the agent a RADIUS stop accounting request to the RADIUS server for all the sessions established by each non-responding NAS.

### FIELD OF THE INVENTION

The present invention generally relates to network access control; more particularly, the present invention aims at improving robustness of a RADIUS accounting server for users connected through a Network Access Server to an IP network.

### BACKGROUND OF THE INVENTION

The access of users to services through a private or public IP network must be controlled for reasons of security and to avoid useless load of the network lines. Companies providing remote access to their servers such as web content servers often share the services of Authentication, Authorization and Accounting (AAA) servers to control the user remote connections. The AAA servers perform authentication of users and check that the remote users are authorized to connect to such servers through the IP network. The AAA servers are also in charge of collecting accurate accounting of connection time so that the users may be billed correctly by the companies.

Network Access Servers (NAS) acting as gateways between the Public Switched Telephone Network (PSTN) and the IP network are installed at the periphery of the IP network. The remote user computer is connected to one modem port of the NAS using a dial-up PPP line connection on the PSTN. The NAS establishes a user session using the services of an AAA server. The AAA server performs the authentication, checking the password received, and provides an authorization to connect according to the network capacity. The NAS sends an IP address to the user and acts as a router to the IP servers once a session is established. When a session is established, the NAS asks the AAA server to start the accounting for this session. When the user hangs up or is disconnected by the network, the NAS asks the AAA server to stop the accounting for this session. One AAA server can collect accounting information for a set of Network Access Servers. Using the accounting information, a bill for the connection to the IP servers is created and sent to the user.

It is noted that the same server can handle Authentication, Authorization and Accounting, but these three functions can be also handled by more than one server. For the purpose of the present invention, it will be assumed that the accounting function is supported by one server that we will call the accounting server.

There is a well known problem of users complaining to the service providers of errors in billing. The errors in billing are most likely due to the inaccuracy of the accounting information gathered by the accounting servers. For most Pre-Paid (on line charging) and Post-Paid billing systems currently deployed in the ISP business, the bill of dial-up connection is started and stopped by the NAS sending messages to the accounting server.

During an established user connection, it may happen that the accounting server is never informed that the session is completed and that the accounting must stop. There are two possible reasons for this:

NAS failure: the user is disconnected, but the NAS is unable to generate the stop accounting request,

network problem: the user is disconnected, the NAS sends a message to the accounting server to stop the accounting, but, due to network failure, the message doesn't reach the server.

This may cause the Pre-Paid or Post-Paid billed customer to be charged for unused connection time. The service provider may accept that a colossal customer bill is an error and can modify a Post-Paid billing. It is more difficult from an administrative point of view to modify ‘Pre-Paid’ billing which would imply decrementing a Pre-Paid card. In both cases the service provider loses money and the customer is unsatisfied and looses confidence.

This problem can be overcome if a network management framework, such as TIVOLI from IBM, is deployed in the network. NETVIEW, a network management platform of TIVOLI, is able to detect that a network node is down using its SNMP agent. When such an error is detected, a task can automatically stop the accounting on the session depending on this node.

No solution exists today to stop accounting in case of bad synchronization between an AAA server and NAS (NAS failure or network failure) in networks that do not have such a framework installed, which is mainly the case with the IP networks which can be either private or public or may be partly private and partly public.

For standardization purposes, certain accounting protocols have been developed that define the accounting information that is to be communicated between the NAS and the accounting server. For instance, the Remote Authentication Dial In User Service (RADIUS) is a client-server type application, the protocol for Authentication and Authorization being defined in the Request For Comment (RFC) documents RFC 2865 and the RADIUS protocol for accounting being defined in the RFC 2866. The Authentication and Authorization may be performed by one type of server and the accounting may be performed by another type of server. The context of the present invention assumes that a RADIUS server is used for accounting.

### SUMMARY OF THE INVENTION

It is therefore an object of the present invention to ensure that the accounting is stopped for the sessions established through an IP network by a NAS, even if the NAS can no longer connect to a RADIUS accounting server through the network.

It is one other object of the present invention to provide a solution that is easy and simple to add to the configurations used today with the IP networks such as the Internet network.

The objects are reached by a method executed by an agent on a computing system, providing robustness to an accounting function of user sessions established by at least one NAS in an IP network, the accounting function being performed on a RADIUS server storing an ID, IP address and secret code for each of the at least one NAS and information identifying each established session, said method comprising the steps of:

identifying for the RADIUS server, the agent as a RADIUS client of the RADIUS server,

polling from the agent the at least one NAS and, if no answer is received from at least one NAS,

sending from the agent a RADIUS stop accounting request to the RADIUS server for all sessions established by the at least one non-responding NAS.

The solution of the present invention does not require the use of a specific network management supervisory function such as with SNMP protocol deployed over a framework. On the contrary, it just requires an agent executing itself near the RADIUS server (in the same subnetwork) and being responsible to detect the loss of connectivity with the NAS. With the solution of the present invention, the NAS communication loss detector agent uses information already collected by the RADIUS server for performing the accounting.

Another advantage of the agent of the present invention is that it is flexible enough to work with current IP server configurations. The agent acts as a RADIUS client for a RADIUS server. In fact, one agent can support a set of RADIUS accounting servers; it just needs to access the accounting server tables. If each accounting server has a disjoint set of users, one agent will be installed for each accounting server or a unique agent will be enabled to access sequentially the tables of all the RADIUS accounting servers. The agent of the present invention can also interface a proxy server if it is used in the IP network configuration. The only recommendation is to have the accounting server or the accounting proxy and the agent belonging to the same subnetwork, which is mostly the case, to ensure that the connectivity between the agent and the accounting server or the accounting proxy is almost always permanently available in order to avoid facing the same kind of problem due to a network problem.

### BRIEF DESCRIPTION OF THE DRAWINGS

FIG. 1 illustrates a computing environment operating the method according to a preferred embodiment of the present invention;

FIG. 2 illustrates the computing environment of the method according to the preferred embodiment when a RADIUS proxy is used;

FIG. 3 illustrates the content of the two tables used according to the method of the preferred embodiment;

FIG. 4 shows a flow chart of the method of the preferred embodiment applying to one NAS only;

FIG. 5 is an illustration of the logical functionalities of the NAS communication loss detector agent according to the preferred embodiment;

FIG. 6 illustrates the data flow between the Network Access Servers, the NAS communication loss detector agent and the RADIUS server;

FIG. 7 describes the Stop accounting request sent by the NAS communication loss detector agent emulating the RADIUS client according to the preferred embodiment.

### DETAILED DESCRIPTION OF THE PREFERRED EMBODIMENT

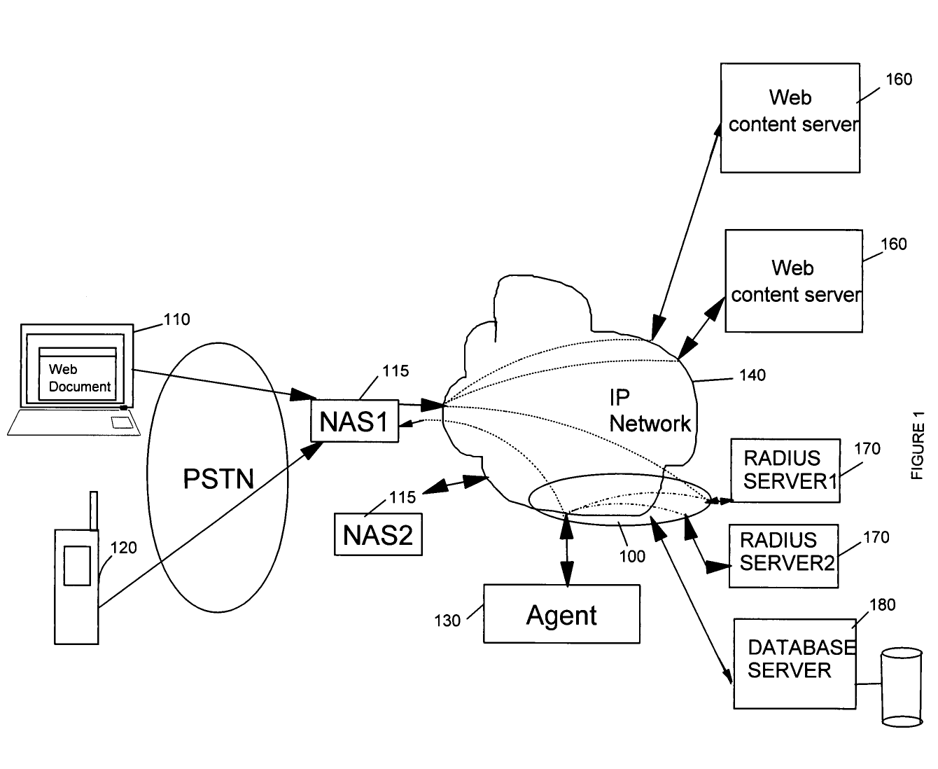

FIG. 1 is a description of the computing environment of the method of the preferred embodiment. The customers (110, 120) have subscribed to services to obtain, for instance, Web documents from Web content servers (160). The customers dial into a NAS (115), NAS1, through a Packet Switched Telephone Network (PSTN). The NAS requests authentication and authorization to the AAA server it depends on for this function. The AAA server performs the Authentication and Authorization and accepts the session with the user.

For simplification of the drawing we do not represent the server handling the Authentication and Authorization functions. We could consider that the Authentication, Authorization and Accounting functions are performed on the same RADIUS server (170). However, in the rest of the document the expression ‘RADIUS server’ is for ‘RADIUS accounting server’, this means that we do not take into consideration if the server supports the authentication and authorization.

Once the session is accepted, the NAS which is the client of the RADIUS server requests to start the accounting for the session. According to the RADIUS accounting protocol as described in RFC 2866 , two types of accounting messages are sent by the NAS to the RADIUS accounting:

start accounting requests

stop accounting requests

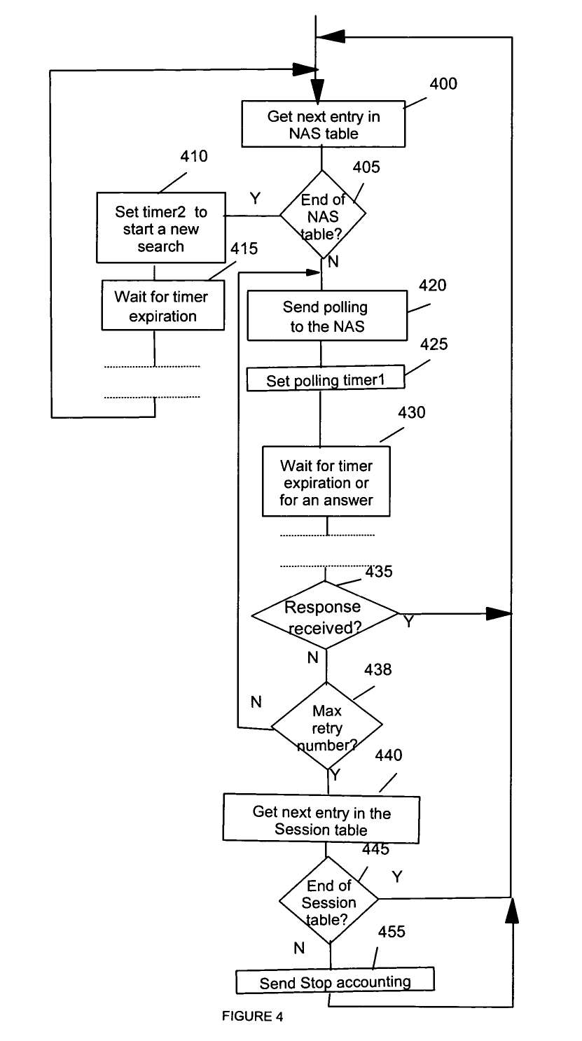

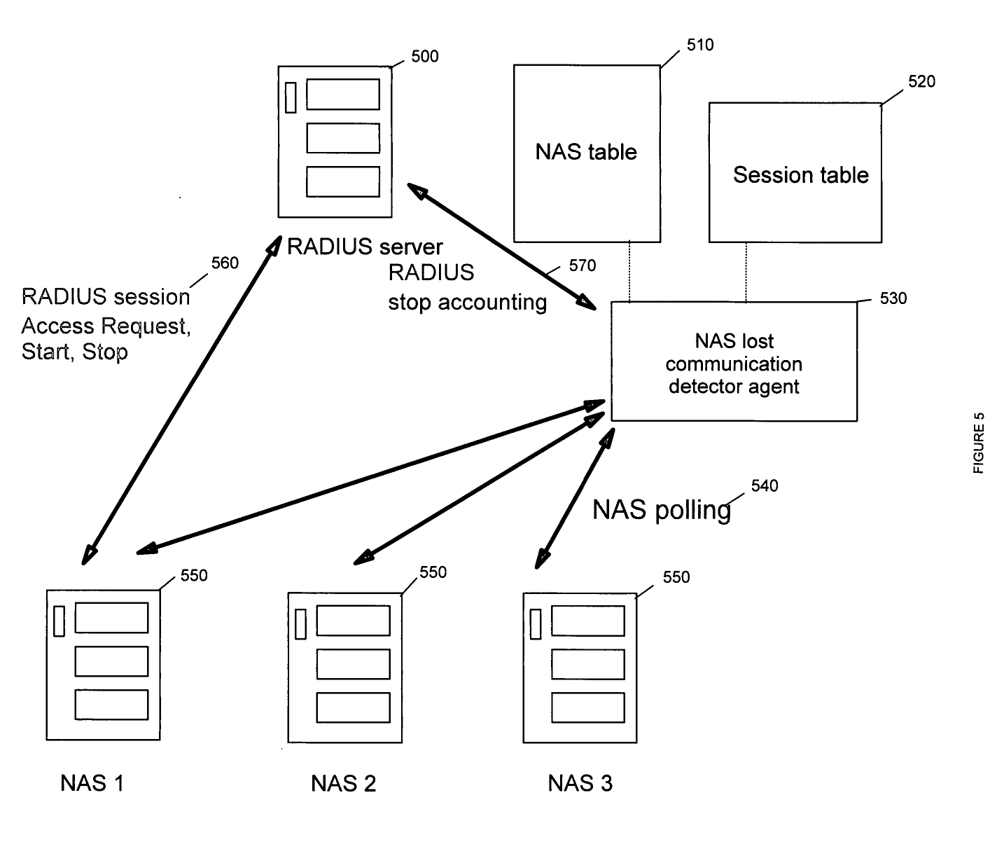

When the accounting has started, the customer can connect to the Web content servers (160). In FIG. 1, the traffic over the IP network is represented with dotted lines. According to the preferred embodiment, during the time of the session, an agent (130) operating on one server controls that the connection between the NAS and the RADIUS server is active. The agent may operate on the RADIUS server or one other server in the network. In the case of NAS connection failure, the agent, acting as a RADIUS client for the RADIUS server, stops the accounting by sending ‘stop accounting’ requests to the RADIUS server (170) in the place of the failing NAS. The steps of the corresponding method are described later in the document, in reference to FIG. 4 and FIG. 5. When the user connection to the web content server is stopped, the NAS (115) requires the RADIUS server (170) to stop the accounting for that session.

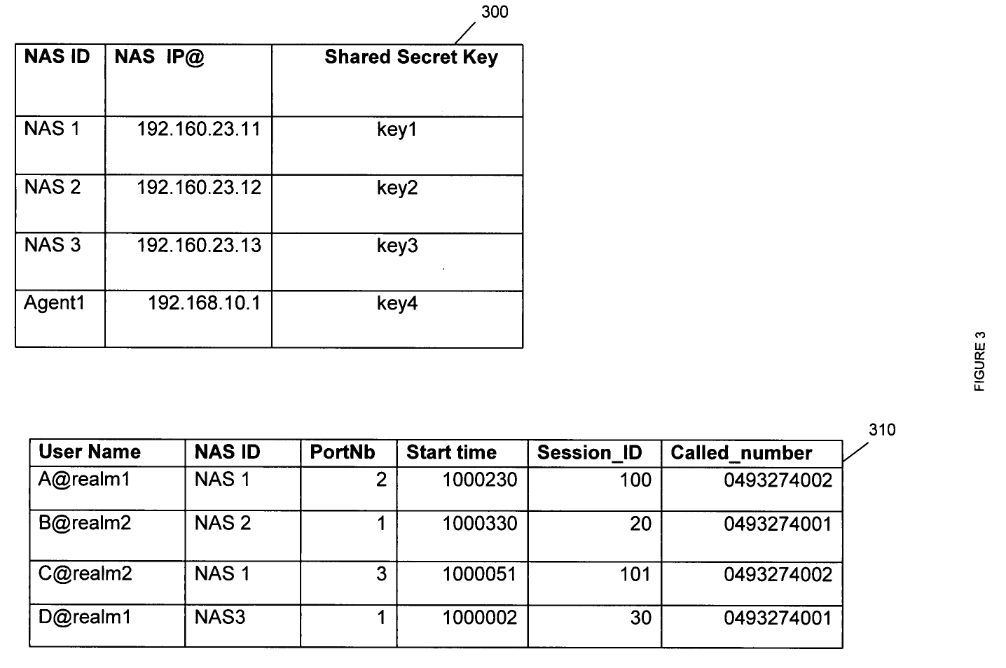

The RADIUS server uses and updates the NAS table and the Session table, which are accessed by the agent. The agent uses only a part of the information stored in the tables as described later in the document in reference to FIG. 3. The tables can be stored on the server or on a separate database server as it is represented in FIG. 1 (180).

It is noted also that one RADIUS server can handle a set of NAS. For simplicity of the representation, assuming that NAS1 and NAS2 depend on the same RADIUS server for accounting, RADIUS server1, only the traffic between NAS1 and that server is represented in FIG. 1 with dotted lines.

The agent (130) which provides robustness to the accounting function of RADIUS server1, can be installed on the same server as RADIUS server1 or another server belonging to the same subnetwork as RADIUS server1. It is also noted that the same agent (130) can support more than one RADIUS server (115). In FIG. 1, for example, the agent (130) supports RADIUS server1 and RADIUS server2. To do so, the agent must be able to access the tables (180) of the two RADIUS servers (170). The only recommendation is to have the RADIUS servers (170) and the agent (130) belonging to the same subnetwork (100). This recommendation is to avoid that an agent belonging to one different subnetwork and having a connection failure in its own subnetwork, is unable to see if a connection is still valid between a NAS and the RADIUS server or is unable to access the database server. The database server (180) belongs, in FIG. 1, to the same subnetwork than the RADIUS servers but this is only one possibility.

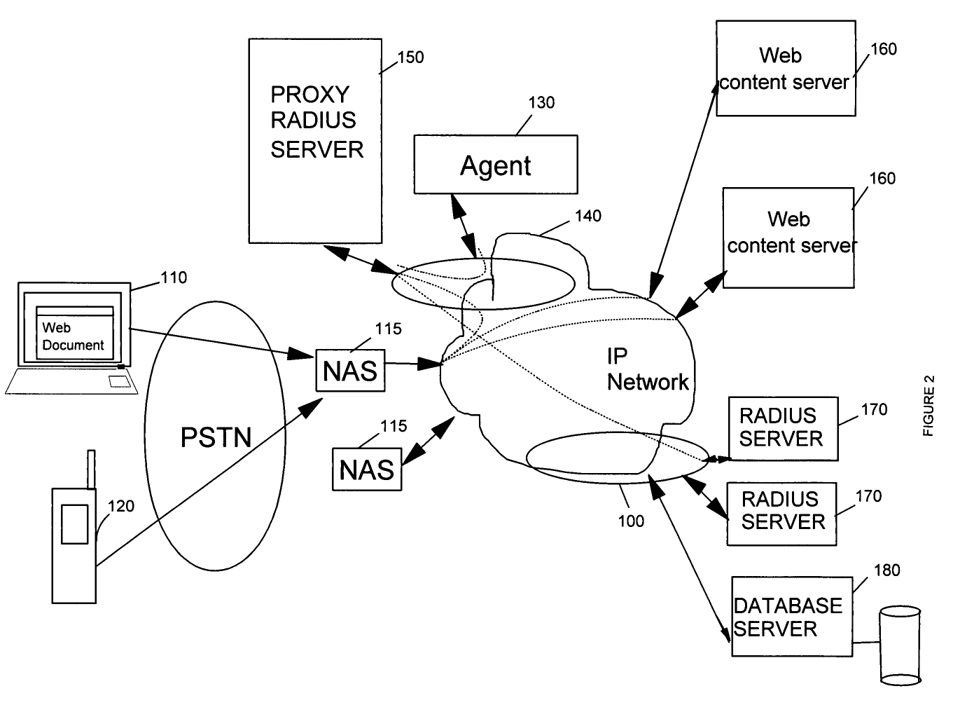

In FIG. 2, the environment of the preferred embodiment is slightly modified because it includes a Proxy RADIUS server (150) in charge of centralizing the NAS requests for a set of RADIUS servers (170). The Proxy server dispatches the requests from the NAS to the corresponding RADIUS server according to the called number or according to other RADIUS attributes. The proxy may be a RADIUS proxy for Authentication, Authorization and/or Accounting. Only the proxy function for an Accounting RADIUS server is relevant for the purpose of the description. When a Proxy is used, the agent (130) also sends the requests to stop the accounting to Proxy RADIUS server (150) instead of the RADIUS servers (170). As per the client-server architecture, the NAS is a RADIUS client, the Proxy acts as a RADIUS server for the NAS and the agent. The Proxy is a RADIUS client for the real RADIUS server (s).

FIG. 3 illustrates the content of the two tables used by the NAS communication loss detector agent. These two tables are owned by the RADIUS server. FIG. 3 describes only the information of these tables that is used by the NAS communication loss detector agent.

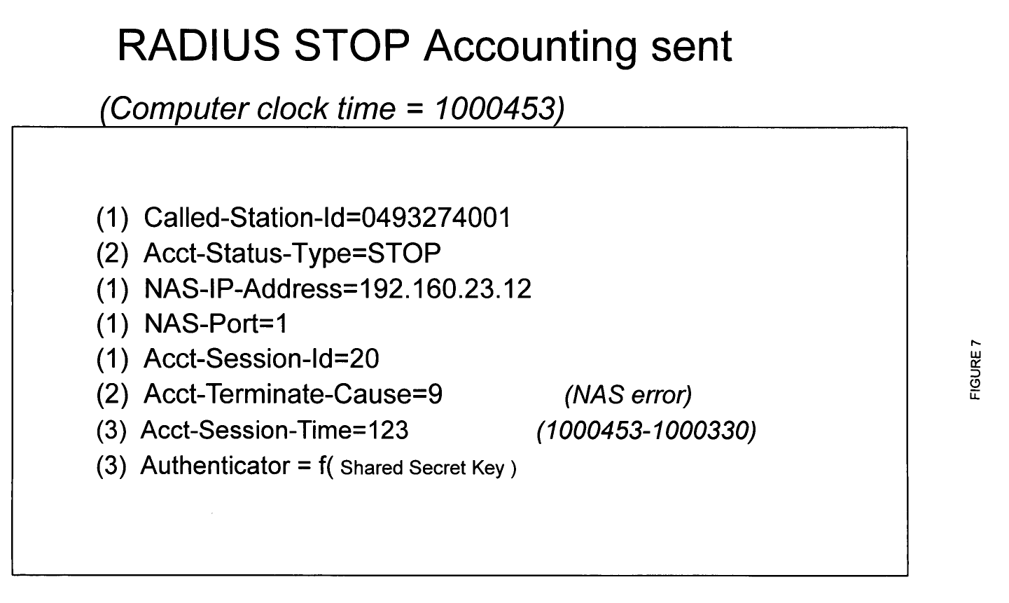

The first table, the NAS table (300) is created at the installation of the RADIUS server. It includes the list of NAS the RADIUS server supports. The table is updated by the administrator each time there is a change in the NAS configuration. Each table entry contains a NAS identifier, the NAS ID and the NAS IP address in the IP network. The NAS table lists all the RADIUS clients from which the RADIUS server will authorize reception of messages under the UDP protocol. Each NAS table entry also contain a shared secret key needed to validate the requests received by the RADIUS server from a RADIUS client. This information is checked by the RADIUS server each time it receives a request from an authorized RADIUS client. It is described in the RFC 2866 as a non-optional parameter to build the RADIUS protocol requests. The shared secret key is used by a RADIUS client, and is used by the NAS communication loss detector agent to compute the authenticator parameter of the stop accounting request as described in reference to FIG. 7.

As discussed in reference to FIG. 1, the NAS table is stored on the RADIUS server or belongs to any IP address element that the server can access in real time. For instance, the tables may be stored in a server database connected to the same subnetwork as the RADIUS server and the NAS communication loss detector agent.

As described later in the document in reference with the flow chart of FIG. 4, the NAS table is read by the NAS communication loss detector agent to generate polling of the different NAS depending on the RADIUS server.

The second table is the Session table (310). One table entry is created by the RADIUS server each time a RADIUS start accounting request is received by the RADIUS server from the NAS and the entry is canceled each time a RADIUS stop accounting request is received by the RADIUS server. This means that one entry corresponds to an active user session handled by one NAS depending on this RADIUS server. The information represented in the session table (310) of FIG. 3 is the minimum information required by the NAS communication loss detector agent. The RADIUS server stores additional information in this table that is not used by the agent. The session ID is assigned by a NAS for one user's session established. It is noted that one session ID can be identical for two NAS, consequently the session ID is not a sufficient parameter to identify a session. The association of the session ID with the NAS ID is required uniquely to identify a session. The information in the session table comes from the parameters provided by the NAS with the RADIUS start accounting request. When receiving the RADIUS stop accounting request, the RADIUS server will use the parameters accompanying this request to select the entry in the session table, to cancel it and prepare the accounting data in a separate file.

The other fields of the session table are as follows:

User Name: this name is used by the subscriber computer for identification and is transmitted to the RADIUS server by the NAS.

Port Nb: is optional, is a hardware parameter provided by the NAS to identify the line entry from the subscriber computer.

Start time: timestamp given by the NAS representing the beginning of the session.

Called_number: it is an optional parameter in a configuration where there is no proxy server. This parameter is necessary if a RADIUS proxy is part of the configuration and if the Called_number is used by the RADIUS proxy server to route the RADIUS requests to correct RADIUS servers. Therefore, in that case, the agent needs to append this attribute to the RADIUS stop accounting requests as described later in the document in reference to FIG. 7.

As described later in the document in reference with the flow chart of FIG. 4, the session table is read by the NAS communication loss detector agent to generate the RADIUS stop accounting request for the sessions active on a NAS it has detected as having lost their network connection to the RADIUS server.

If a unique NAS communication loss detector agent supports more than one RADIUS server, there will be as many sets of two tables as the number of RADIUS servers, each set being accessed by the agent. In the configuration as described in FIG. 1 or FIG. 2, the sets of two tables are on the database server. In the NAS tables for RADIUS server 1 and for RADIUS server 2 are included the same agent ID and agent IP address.

It is noted that one RADIUS server may have more than one NAS communication loss detector agent entry in the NAS table. If this is the case, the agents having an entry in the NAS table use this same NAS table. The radius server will maintain and use as many session tables as the number of different agents. Each session table corresponds to an independent set of NAS, all depending on the same RADIUS server. The session tables may be disjoint because they store the entry for sessions corresponding to different sets of users, for different affiliates of a same company, for instance. Each agent uses one session table independently from the other agent.

However, in one other possible configuration even if there is a disjoint session table for a same RADIUS sever, one NAS communication loss detector agent may be sufficient. The agent reads sequentially all the session tables each time it prepares the parameters to build the RADIUS stop accounting request. In this case, the unique NAS table for this RADIUS server will only include one entry for this agent.

When there are more than one RADIUS server supported by the NAS communication loss detector agent and as suggested in reference to FIGS. 1 and 2, the agent polls successively all the NAS depending on the first RADIUS server and all the NAS depending on the second RADIUS server. To build the RADIUS stop accounting request, the agent knowing already the NAS ID, knows which session table it has to read.

These are variations of the method illustrated with the flow chart described in reference to FIG. 4. The generation parameters (timer 1, timer 2 and number of max retry) of the NAS communication loss detector agent should be adapted to these specific configurations.

FIG. 4 shows the general flow chart of the method of the preferred embodiment. For reason of simplification, the method as described applies to an environment comprising one RADIUS server controlling a set of Network Access Servers.

The NAS table is read (400) from the RADIUS server. If there is an entry read (answer N to test 405), a polling is sent to the NAS from the agent (420) and a polling timer (timer 1, first generation parameter of the NAS communication loss detector agent) is set (425). Waiting for the timer expiration (430), if a response is received during this time (answer Yes to test 435), a next entry is read in the NAS table (400). If a response is not received during this time (answer No to test 435), and if the number of retries has not reached a maximum retry number (one other generation parameter of the NAS communication loss detector agent), this means that the answer to test 438 is No, a new polling is sent to the NAS (420). If the maximum of retry is reached (answer Yes to test 438), the Session table is read (440). If one entry for that NAS exists (answer No to test 445), a RADIUS stop accounting request is sent to the RADIUS server as if this request was sent from the NAS handling the session. The information read in the Session table is used to build the Stop accounting request. If the Session table has been entirely read for the selected NAS (answer Yes to test 445), a next entry is read in the NAS table (400). When the NAS table has been entirely read (answer Yes to test 405), a timer (timer 2, a third generation parameter of the NAS communication loss detector agent) is started (410) before sending a new sequence of pollings towards the Network Access Servers (415). The timer value depends on the configuration and particularly the number of NAS and Sessions handled by the NAS equipment.

FIG. 5 illustrates the logical blocks corresponding to the functions of the method of the preferred embodiment applied to an environment including more than one NAS. NAS1, NAS2 and NAS 3 (550) are RADIUS clients exchanging messages (560) with the RADIUS server (500). If User B performs a dial-in to NAS 2 in order to access services. The user presents authentication information to the RADIUS client of the NAS. The RADIUS client sends to the RADIUS server an ‘Access request’ (560) containing such attributes as the user's name, the password, the NAS-ID, the NAS IP address and the Port ID the user is accessing. Once, after authentication and authorization performed, the RADIUS server sends back an ‘access accept’ (560) to the RADIUS client, NAS 2 starts the User B session and starts accounting by sending a ‘start accounting’ (560) request received by the RADIUS accounting server. The NAS communication loss detector agent reads the tables (510) and polls all the Network Access Servers identified in the NAS table according to the method as described in reference to the flow chart of FIG. 4. In the normal case, if User B stops the connection, NAS 2 stops the session and sends a ‘stop accounting’ request (570) to the RADIUS server for User B session (user name is B@realm2 as read in the session table of the example of FIG. 3). In case where the NAS communication loss detector agent polling NAS 2 identifies a connection lost with this NAS, it acts in place of NAS 2 and generates the ‘stop accounting’ request towards the RADIUS server for the User B session and all the sessions identified as activated in the session table (520) for that NAS 2.

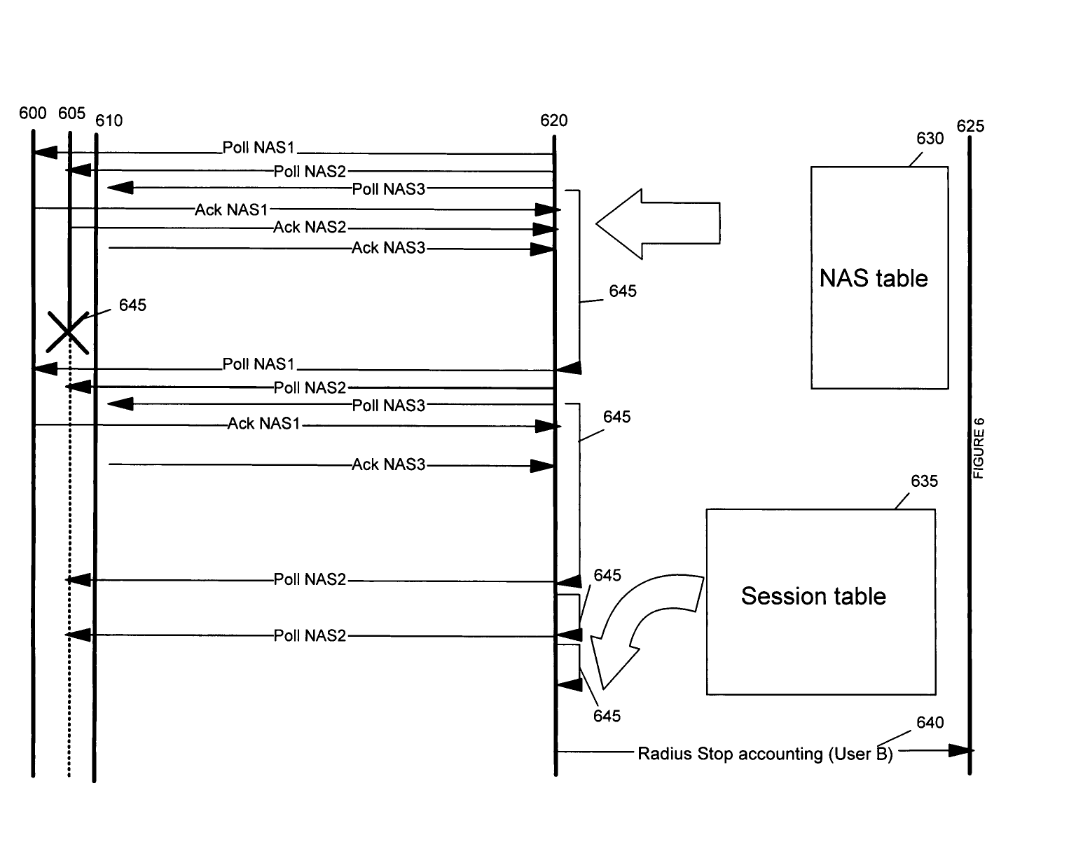

FIG. 6 illustrates the data flow between NAS 1 (600), NAS 2 (605), NAS 3 (610), the NAS communication loss detector agent (620) and the RADIUS server (625). Time is represented as passing top down the vertical lines (600, 605, 610, 615, 620, 625). The NAS communication loss detector agent reading the IP addresses in the NAS table (630) polls sequentially NAS 1, NAS 2 and NAS 3 and receives back the acknowledgment from NAS 1, NAS 2 and NAS 3. If a failure occurs on NAS 2 (645), the next polling to NAS 2 will be never answered. This is illustrated with the following sequence of polling: (Poll NAS 1, Poll NAS 2 and Poll NAS 3) which is answered by NAS 1 and NAS 3 but not by NAS 2. It is noted that the sequences of polling to all the Network Access Servers of the NAS table are performed with a fixed interval (645) of time (step 410 and 415 of FIG. 4) which can be set as a generation parameter of the NAS communication loss detector agent. After a configurable number of retries on polling of NAS 2 (max number of retry generation parameter set to 3), the NAS communication loss detector agent (620) sends a ‘stop accounting’ request to the RADIUS server (625). The ‘stop accounting’ applies to each active session handled by NAS 2 as read in the Session table (635). The ‘stop accounting’ request is built using all the information stored in the session table for this session. This request is sent to the RADIUS server to follow the example of FIG. 3 as the B@realm2 User name is active on NAS 2.

FIG. 7 illustrates a possible set of parameters of the ‘stop accounting’ request generated by the NAS communication loss detector agent. The parameters annotated with (1) are those of the Start accounting request sent by the RADIUS client to the server when the NAS initializes the session. These parameters have been saved by RADIUS server in the Session table and they are read from the session table. The agent sets the parameters annotated with (2) ‘Stop’ and ‘9’. The NAS communication loss detector agent computes also parameters indicated as (3) in FIG. 7. The first computed parameter is the accounting time duration of the session by making the difference between the current machine time and the Start accounting time saved in the Session table. The RADIUS stop accounting request is sent by the NAS communication loss detector agent and is accepted by the RADIUS server which uses the NAS table to check if the agent is authorized to communicate with itself. The RADIUS server stops the accounting for that session and delete the corresponding entry in the session table. The second computed parameter is the Authenticator which is computed as a function of the Shared secret key stored in the session table. The Authenticator is provided by the agent to the RADIUS server which checks it against the entry in the NAS table and accepts the stop accounting request if it is correct for that NAS.

A minimum set of parameters in the Stop accounting request is chosen in the preferred embodiment. This minimum set would not include parameters which could be retrieved by the RADIUS server. The parameters that can be suppressed are indicated as ‘optional’ in the RFC 2866 describing the RADIUS accounting protocol between the RADIUS client and the RADIUS server. The Stop accounting must contain the accounting status type (Acct-Status-Type=STOP), the accounting session time (Acct-Session-Time=123), a parameter used to identify the NAS and the session attached to that NAS. The NAS can be identified by the NAS IP address (NAS-IP-Address=192.160.23.12) or the NAS ID (NAS-ID=NAS 2). One other parameter is necessary to identify the session. It could be the session ID (Acct-Session-Id=20) or the NAS port (NAS-Port=1).

The termination cause (Acct-Terminate-Cause=9) is optional for accounting. It can be stored by the RADIUS server to prepare inputs for statistical computations.

In a configuration including a proxy, as described in reference to FIG. 2, an additional parameter, the called number (Called-Station-Id=0493274001) is used if the RADIUS proxy needs this information to route RADIUS requests to the correct RADIUS servers.

The NAS connection failure to the RADIUS server has been detected by the NAS communication loss detector agent. There are two possibilities, either the user has already terminated his connection and the session duration of the accounting data which will be used for billing the user will be slightly and not perceptibly higher than reality, or the user has not completed the connection and the billing will be lower than reality. The user will not complain and the service provider company will not loose too much. In either case, the service provider company will never loose credibility for unrealistic billing.

It is noted that when a NAS connection failure has been detected by the NAS communication loss detector agent, this failure can correspond to a failure also in the NAS itself and not only of the connectivity. This means that, in this case, as the NAS is a router for the user computer connections, all the connections on the NAS are down. The part played at this time by the NAS communication loss detector agent is fully justified.

1. A method executed by an agent on a computing system, providing robustness to an accounting function of user sessions established by at least one NAS in an IP network, the accounting function being performed on a RADIUS server storing an ID, IP address and secret code for each of the at least one NAS and information identifying each established session, said method comprising the steps of:
identifying for the RADIUS server, the agent as a RADIUS client of the RADIUS server,
polling from the agent the at least one NAS and, if no answer is received from at least one non-responding NAS,
sending from the agent a RADIUS stop accounting request to the RADIUS server for all sessions established by the at least one non-responding NAS.

2. The method of claim 1, wherein the identifying step comprises the step of storing the ID, the IP address and the secret code of the agent.

3. The method of claim 1, wherein the polling step comprises the step of waiting for an expiration of a timer which is a first parameter defined during an installation of the agent.

4. The method of claim 1, wherein the polling step is repeated n times, n being an integer defined at an installation of the agent.

5. The method of claim 1, wherein the polling step and the sending step further comprise a step of reading a table owned by the RADIUS server containing one entry per established session and, for each entry, information to identify the NAS and prepare parameters for the RADIUS stop accounting request.

6. The method of claim 5, wherein the sending step comprises a preliminary step, after reading the established session table, of, including as parameters of the RADIUS stop accounting request: accounting status, accounting session time, a NAS identifier; a session identifier and an authenticator.

7. The method of claim 6 further comprising the steps of:
computing the accounting session time by subtracting the session start time read in the established session table from a current computing system timestamp; and,
computing the authenticator as a function of the secret code read with the ID and the IP address stored for the corresponding NAS.

8. A computer program product comprising programming code instructions for executing the steps of the method according to of claim 1 when said program is executed on a computing system.

9. A computing system comprising means adapted for carrying out the method according to of claim 1.
